(19) United States
(12) Patent Application Publication
(10) Pub. No.: US 2026/0288513 A1
(43) Pub. Date: Sep. 24, 2026

(54) SELECTING WORK SLICE

(71) Applicants: Benjamin Lewis, Logan, UT (US); Todd Wilson, Logan, UT (US); Charles Swenson, Logan, UT (US); Jonathan Phillips, Logan, UT (US); Kade Howes, Logan, UT (US); Shawn Jones, Logan, UT (US)

(72) Inventors: Benjamin Lewis, Logan, UT (US); Todd Wilson, Logan, UT (US); Charles Swenson, Logan, UT (US); Jonathan Phillips, Logan, UT (US); Kade Howes, Logan, UT (US); Shawn Jones, Logan, UT (US)

(73) Assignee: Utah State University, Logan, UT (US)

(21) Appl. No.: 19/570,915

(22) Filed: Mar. 18, 2026

Related U.S. Application Data
(60) Provisional application No. 63/774,671, filed on Mar. 19, 2025.

(51) Int. Cl. G06F 9/48

(52) U.S. Cl. CPC G06F 9/485

(57) ABSTRACT

For selecting a workflow slice, a method receives an operation workflow for a compute system comprising at least two compute units. The method generates at least two workflow slices randomly within a solution space of allocations of the operation workflow to the compute units. The method determines a solution score for each workflow slice. The method further iteratively generates a cousin workflow slice adjacent to each workflow slice with a solution score that satisfies a solution score criteria. In response to satisfying a stop criteria, the method selects a workflow slice with a highest solution score.

### FEDERALLY SPONSORED RESEARCH AND DEVELOPMENT

This invention was made with government support under 80NSSC23M0241 awarded by the National Aeronautics and Space Administration. The government has certain rights in the invention.

### BACKGROUND INFORMATION

The subject matter disclosed herein relates to selecting a workflow slice for a workflow operation.

### BRIEF DESCRIPTION

A method for selecting a workflow slice is disclosed. The method receives an operation workflow for a compute system comprising at least two compute units. The method generates at least two workflow slices randomly within a solution space of allocations of the operation workflow to the compute units. The method determines a solution score for each workflow slice. The method further iteratively generates a cousin workflow slice adjacent to each workflow slice with a solution score that satisfies a solution score criteria. In response to satisfying a stop criteria, the method selects a workflow slice with a highest solution score. An apparatus and computer readable program product that perform the method are also disclosed.

### BRIEF DESCRIPTION OF DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a compute system;

FIG. 1B is a schematic block diagram illustrating one embodiment of a compute unit;

FIG. 2A is a schematic block diagram illustrating one embodiment of compute data;

FIG. 2B is a schematic block diagram illustrating one embodiment of a workflow slice;

FIG. 3A is a schematic block diagram illustrating one embodiment of an operation workflow;

FIG. 3B is a schematic block diagram illustrating one embodiment of a workflow slice for an operation workflow;

FIG. 3C is a schematic block diagram illustrating one alternate embodiment of a workflow slice for an operation workflow;

FIG. 4A-D are schematic diagrams illustrating embodiments of a solution space;

FIG. 5 is a schematic block diagram illustrating one embodiment of a computer; and

FIG. 6 is a schematic flow chart diagram illustrating one embodiment of a workflow slice selection method.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

Program code for carrying out operations for aspects of the present invention may be written in any combination of one or more programming languages, including an object-oriented programming language such as MATLAB, Python, Ruby, R, Java, Java Script, Julia, Go, Smalltalk, C++, C sharp, Lisp, Clojure, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The computer program product may be shared, simultaneously serving multiple customers in a flexible, automated fashion.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

This patent application incorporates by reference the entire contents of the following documents: “2024 Aug. 23 Review_updated. pdf”, “D2025-0031 (C25017) Disclosure. pdf”, “LACE_C3A_compiler_v4.pdf”, and “LACE_Overview.pdf”. These documents provide detailed descriptions of the invention's design, requirements, and implementation.

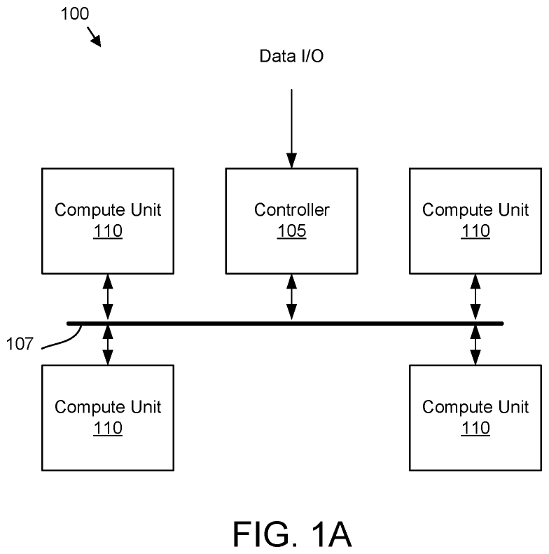

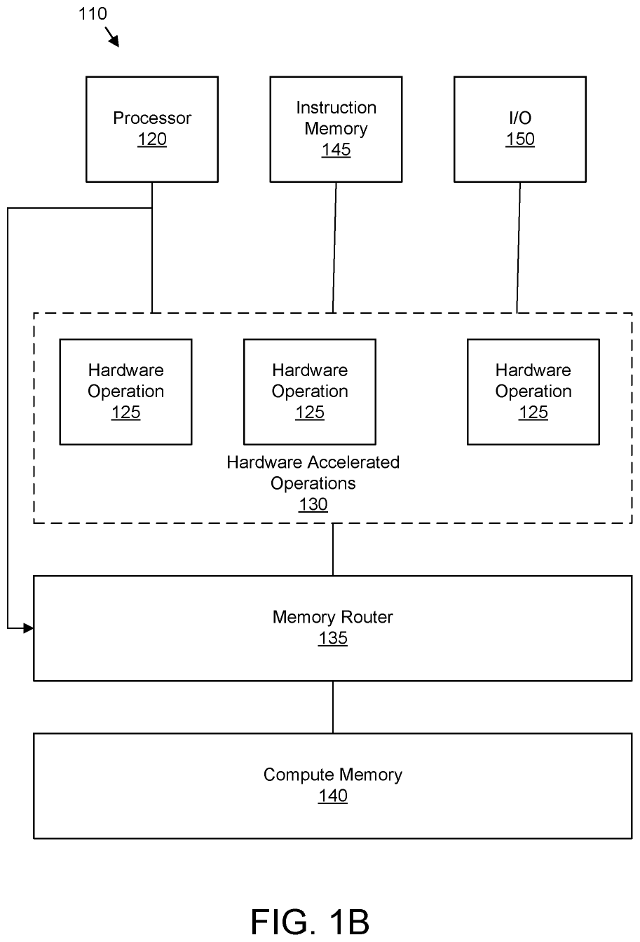

FIG. 1A is a schematic block diagram illustrating one embodiment of the compute system 100. The compute system 100 may comprises at least two compute units 110. In the depicted embodiment, the compute system 100 comprises four compute units 110 and a controller 105 that communicates with the plurality of compute units 110. A controller 105 serves as the primary communication point for the compute units 110. An operation workflow is received by the controller 105, which then utilizes a translator to generate executable code that is distributed to each of the compute units 110. The compute system 100 may be designed for low-power edge computing.

The controller 105 may communicates with the compute units 110 using a single point of contact network on a bus 107. The controller 105 may function as a router, routing packets between the compute units 110. In one embodiment, the compute units 110 are only connected to the controller 105, forming the single point of contact network. The controller 105 may filter data packets and forwards the data packets to the compute units 110 based on subscriptions. Output packets from the compute units 110 are sent to the controller 105.

The compute system 100 may execute an operation workflow. The operation workflow may be an Open Neural Network Exchange (ONNX) model. The operation workflow comprises a plurality of tasks. The tasks are allocated to the compute units 110 and to hardware operations within the compute units 110 for execution. Some tasks must be executed in a specified order. Some tasks may be executed in parallel. An allocation of the tasks to compute units 110 and within computer units 110 is referred to herein as a workflow slice. There may be a vast number of potential workflow slices for a given operation workflow, many more than could be explored in within a reasonable time. The embodiments disclosed herein select a workflow slice 223 for the operation workflow that improves the reliability, efficiency, and effectiveness of the execution of the operation workflow as will be described hereafter.

In one embodiment, the compute system 100 includes a translator that selects the workflow slice and generates executable code for the selected workflow slice. Alternatively, a computer may select the workflow slice and generate the executable code. In a certain embodiment, the computer selects the workflow slice and the computer system 100 generates the executable code for the selected workflow slice.

In one embodiment, the compute system 100 uses the Consultative Committee for Space Data Systems (CCSDS) space packet protocol for communication between the compute system 100 and a spacecraft.

FIG. 1B is a schematic block diagram illustrating one embodiment of a compute unit 110. The compute unit 110 may comprise and/or be embodied in one or more field programmable gate arrays (FPGA). In the depicted embodiment, the compute unit 110 comprises a processor 120, instruction memory 145, input/output (I/O) 150, hardware accelerated operations 130, a memory router 135, and a compute memory 140. The instruction memory 145 stores executable code generated for the selected workflow slice. The processor 120 executes the executable code. The executable code may direct the communication of data via the I/O 150, the processing of data with hardware operations 125 in the hardware accelerated operations 130, and retrieving and storing data in the compute memory 140 using the memory router 135.

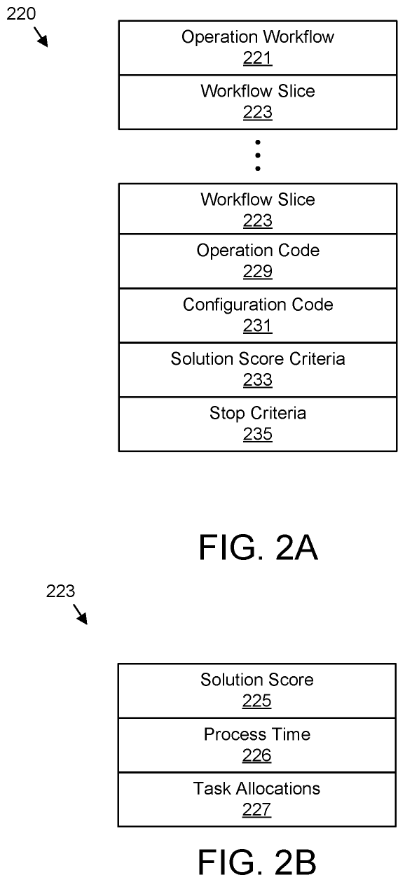

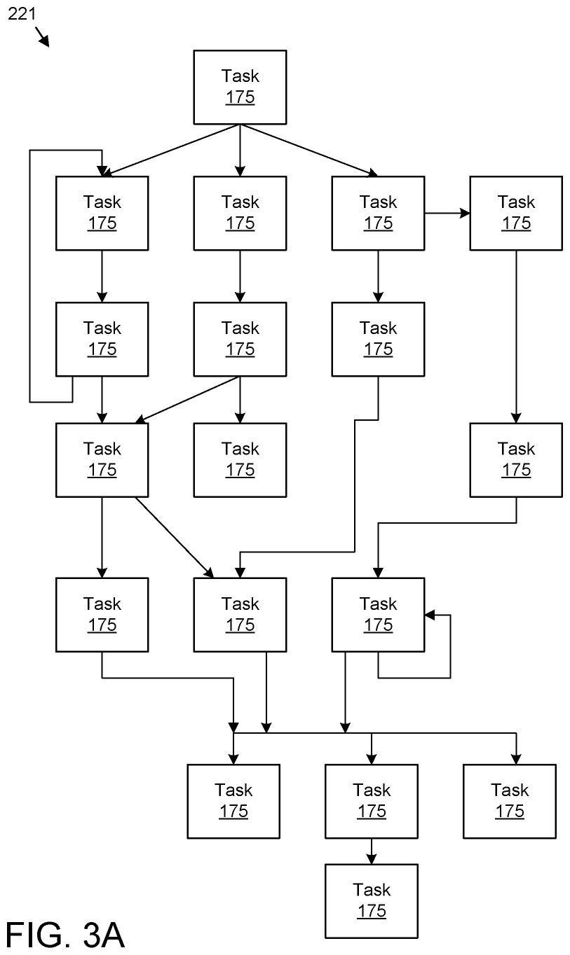

FIG. 2A is a schematic block diagram illustrating one embodiment of compute data 220. The compute data 200 may be organized as a data structure in a memory such as the compute memory 140 or the like. The compute data 220 includes the operation workflow 221, a plurality of workflow slices 223, operation code 229, configuration code 231, solution score criteria 233, and stop criteria 235.

The operation workflow 221 specifies the operations to be performed by the compute system 100. The operation workflow may be an ONNX model. Each workflow slice 223 specifies an allocation and/or order of execution of tasks to the processors 120 and hardware operations 125 of the compute units 110.

The operation code 229 may specify code executed by the hardware operations 125. For example, the operation code 229 may specify each task performed by each hardware operation 125 of an FPGA. The configuration code 231 may configure hardware operations 125 on the compute units 110. For example, the configuration code 231 may configure a multiply-accumulator on an FPGA.

The solution score criteria 233 comprises parameters for evaluating solution scores. In one embodiment, the solution score criteria 233 may be a lower bound for an acceptable solution score. The solution score criteria 233 may be a maximum process time for an operation workflow 221. In addition, the solution score criteria 233 may be a desired process time for the operation workflow 221.

The stop criteria 235 may specify when to stop exploring workflow slice 223 options and select a workflow slice 223. In one embodiment, the stop criteria 235 comprises a selection time limit and is satisfied when the selection time limit is exceeded. In a certain embodiment, the stop criteria 235 comprises a desired process time for the operation workflow 221 and is satisfied when a workflow slice 223 is found with a process time less than the desire process time.

FIG. 2B is a schematic block diagram illustrating one embodiment of a workflow slice 223. In the depicted embodiment, the workflow slice includes a solution score 225, a process time 226, and task allocations 227. The process time 226 estimates the time required for the workflow slice 223 to execute the operation workflow 221 on the compute system 100. The solution score 225 quantitatively and/or qualitatively indicates the ability of the workflow slice 223 to execute the operation workflow 221. The solution score 225 may incorporate the process time 226. The task allocations 227 indicate the allocation of tasks to the compute system 100 and the order of operation for the tasks.

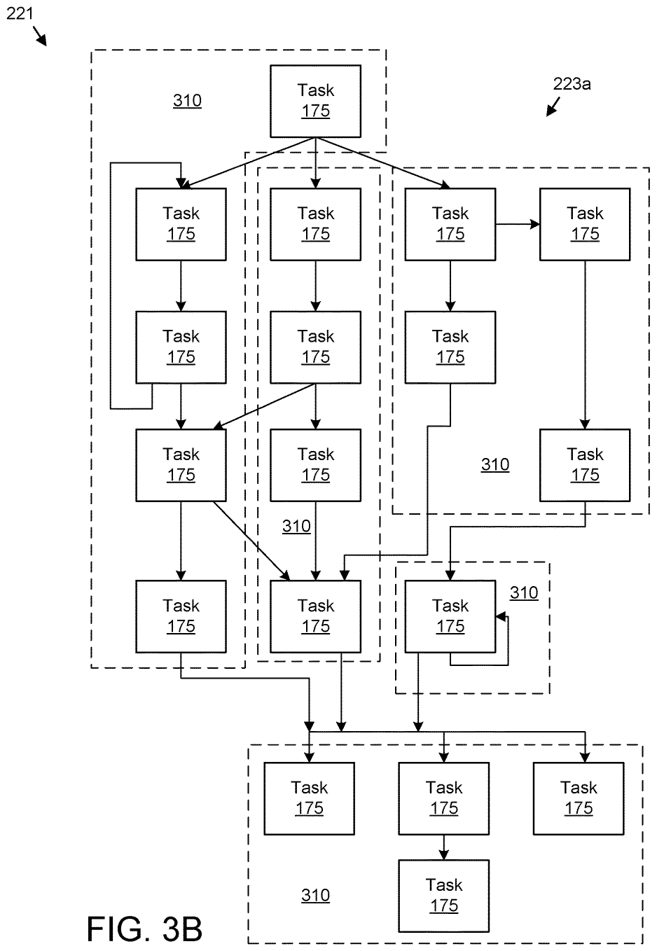

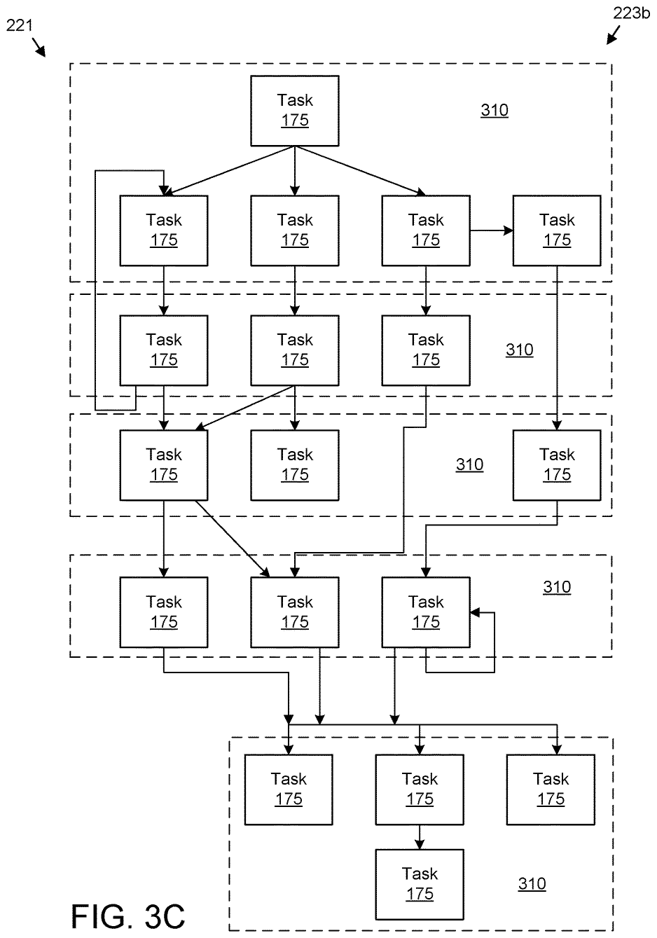

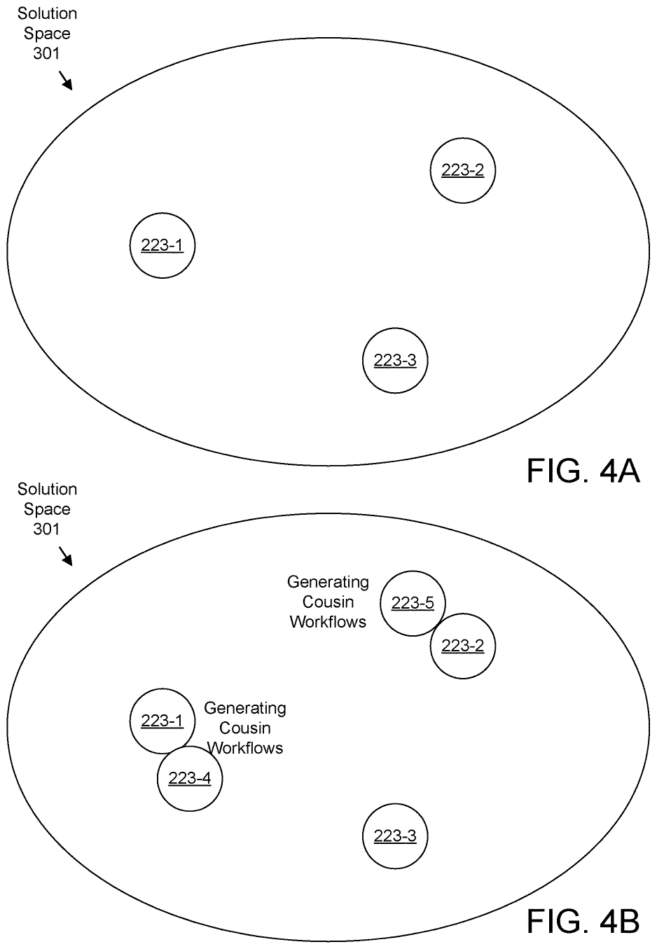

FIG. 3A is a schematic block diagram illustrating one embodiment of an operation workflow 221. For illustration, the operation workflow 221 is greatly simplified. The operation workflow 221 comprises a plurality of tasks 175. Some tasks 175 provide data for other tasks 175 and so must be completed before the other tasks 175 are started. The tasks 175 may be allocated to the hardware operations 125 and compute units 110 of the compute system 110 with many different workflow slices 223. Because of the large number of tasks 175 in a typical operation workflow 221, as well as the many available hardware operations 125, the number of potential workflow slices 223 is extremely large. As a result, a best or even better solution cannot be found through brute force trial and error.

FIG. 3B is a schematic block diagram illustrating one embodiment of a first workflow slice 223a for the operation workflow 221 of FIG. 3A. In the depicted embodiment, the tasks 175 are divided into allocations 310 for processors 120 and hardware operations 125 and/or compute units 110. The allocations 310 may also specify how data is passed between processors 120, hardware operations 125, and/or compute units 110.

The allocations 310 may be stored as task allocations 227 for the workflow slice 223a. A process time 226 and/or solution score 225 may be calculated for the workflow slice 223a.

FIG. 3C is a schematic block diagram illustrating one embodiment of a second workflow slice 223b for the operation workflow 221 of FIG. 3A. In the depicted embodiment, the tasks 175 are divided into alternate allocations 310 for hardware operations 125 and/or compute units 110.

The allocations 310 may be stored as task allocations 227 for the workflow slice 223b. A process time 226 and/or solution score 225 may be calculated for the workflow slice 223b.

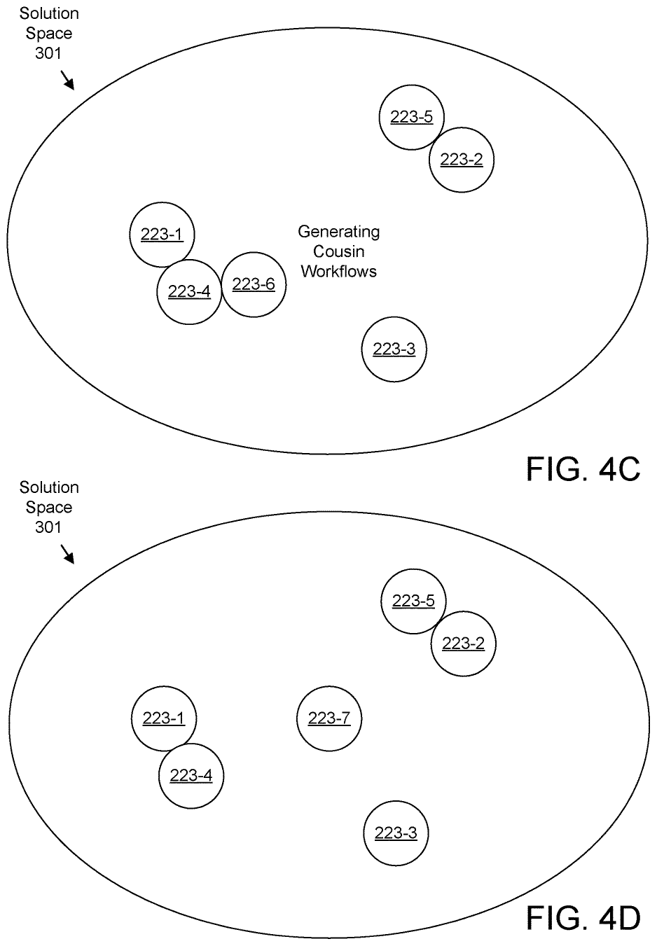

FIG. 4A-D are schematic diagrams illustrating embodiments of a solution space 301. A solution space 301 is a graphical representation of the set of all workflow slices 223. Locations within the solution space 301 represent specific workflow slices 223. The depicted embodiment is a two dimensional representation of the solution space 301. However, the solution space 301 is an n dimensional representation. In one embodiment, n is the number of allocations 310 for all tasks 175. Alternatively, n may be selected as the number of allocations 310 for a subset of tasks 175.

In the depicted embodiment, three workflow slices 223 are randomly selected within the solution space 301. Any number of workflow slices 223 may be randomly selected. At least two workflow slices 223 are randomly selected within the solution space 301. The code for the selected workflow slices 223 is generated and a solution score 225 is determined for each selected workflow slice 223 using the generated code.

In FIG. 4B, the embodiments iteratively generate cousin workflow slices 223 adjacent to each workflow slice 223 with a solution score 225 that satisfies the solution score criteria 233. Cousin workflow slices 223 differ by no more than m allocations 310 of tasks 175. In one embodiment, m is in the range of 1-100 allocations 310. In a certain embodiment, m is in the range of 1-10 allocations 310.

In the depicted embodiment, a cousin workflow 223-4 is generated adjacent to workflow slice 223-1 in response to workflow slice 223-1 satisfying the solution score criteria 233. Similarly, cousin workflow 223-5 is generated adjacent to workflow slice 223-2 in response to workflow slice 223-2 satisfying the solution score criteria 233. No cousin workflow 223 is generated for workflow 223-3 as workflow 223-3 did not satisfy the solution score criteria 233.

In FIG. 4C, the embodiments further iteratively generate cousin workflow slices 223 adjacent to each workflow slice 223 with a solution score 225 that satisfies the solution score criteria 233. In the depicted embodiment, cousin workflow slice 223-6 is generated adjacent to workflow slice 223-4 in response to workflow slice 223-4 satisfying the solution score criteria 233.

In FIG. 4D, the embodiments alternatively generate an additional workflow slice 223-7 in response to no workflow slices 223 satisfying the solution score criteria 233. The additional workflow slice 223-7 is generated randomly within the solution space 301. In the depicted embodiment, the additional workflow slice 233-7 is generated in response to no workflow slices 233 from the proceeding generation satisfying the solution score criteria 233. In one embodiment, the additional workflow slice 223-7 is generated in response to the workflow slices 223 not satisfying the stop criteria 235.

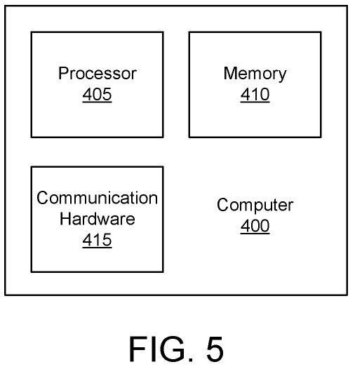

FIG. 5 is a schematic block diagram illustrating one embodiment of a computer 400. In the depicted embodiment, the computer 400 includes a processor 405, a memory 410, and communication hardware 415. Although one processor 405, one memory 410, and one communication hardware 415 is shown, any number of processors 405, memories 410, and communication hardware blocks 415 may be employed. The memory 410 may store code and data. The processor 405 may execute the code and process the data. The computer 400 may communicate with other devices through the communication hardware 415.

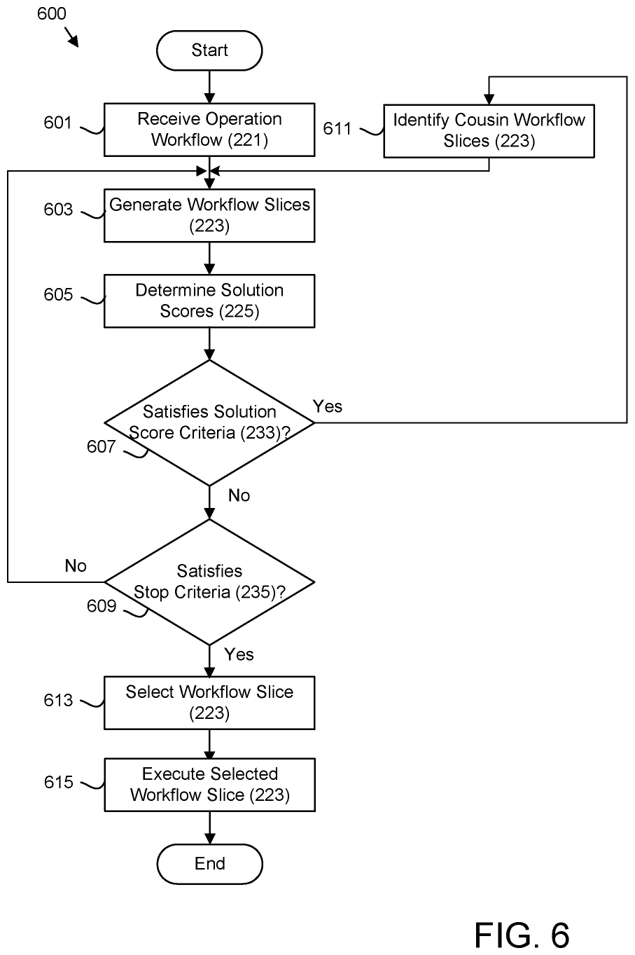

FIG. 6 is a schematic flow chart diagram illustrating one embodiment of a workflow slice selection method 600. The workflow slice selection method 600 selects a workflow slice 223 from the solution space 301 for execution on the compute system 100. The method 600 may be performed by the compute system 100 or the computer 400.

The method 600 starts and receives 601 an operation workflow 221 for the compute system 100. The method 600 further generates 603 at least two workflow slices 223 randomly within the solution space 301 of allocations 310 of the operation workflow 221 to the compute units 110 as shown in FIG. 4B.

The method 600 determines 605 solution scores 225 for each new workflow slice 223. In one embodiment, the method 600 generates code for each workflow slice 223 and estimates the process time 226 and/or solution score 225 for each workflow slice 223.

The method 600 determines 607 if any of the workflow slices 223 satisfy the solution score criteria 233. If at least one workflow slice 223 satisfies the solution score criteria 223, the method 600 identifies at least one cousin workflow slice 223 adjacent to each workflow slice 223 with a solution score 225 that satisfies a solution score criteria 233 and generates 603 the identified cousin workflow slices 223. If no workflow slice 223 satisfies the solution score criteria 223, the method 600 determines 906 if any workflow slice 223 satisfies the stop criteria 235. If no workflow slice 223 satisfies the stop criteria 235, the method 600 randomly generates an additional workflow slice 223 within the solution space 301. If at least one workflow slice 223 satisfies the stop criteria 235, the method 600 selects 613 the workflow slice 223 with the highest solution score 225. In one embodiment, the method 600 executes the selected workflow slice 223 with the compute system 100.

The embodiments improve the reliability, effectiveness, and efficiency of selecting a workflow slice 223 for an operation workflow 221. By randomly generating and evaluating workflow slices 223 and then iteratively generating cousin workflow slices 223, the embodiments effectively evaluate the workflow slices 223 in the solution space. By determining solution scores 225 for each workflow slice 223 and comparing the solution scores 225 to the solution score criteria 233, the embodiments reliably select workflow slices 223 with a desired performance and that efficiently perform the operation workflow 221. As a result, the operation of the compute system 100 is improved.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method comprising:
receiving an operation workflow for a compute system comprising at least two compute units;
generating at least two workflow slices randomly within a solution space of allocations of the operation workflow to the compute units;
determining a solution score for each workflow slice;
iteratively generating a cousin workflow slice adjacent to each workflow slice with a solution score that satisfies a solution score criteria; and
in response to satisfying a stop criteria, selecting a workflow slice with a highest solution score.

2. The method of claim 1, the method further comprising randomly generating an additional workflow slice within the solution space in response to no workflow slices exceeding the solution score criteria.

3. The method of claim 1, the method further comprising executing the selected workflow slice with the compute system.

4. The method of claim 1, wherein cousin workflow slices differ by no more than ten allocations of tasks.

5. The method of claim 1, wherein the solution score comprises a process time.

6. The method of claim 1, wherein the stop criteria comprises a selection time limit.

7. The method of claim 1, wherein the operation workflow is an Open Neural Network Exchange (ONNX) workflow.

8. The method of claim 1, wherein the compute system comprises at least four compute units and a controller that communicates with the plurality of compute units.

9. The method of claim 8, wherein the controller and the compute units communicate using a single point of contact network.

10. An apparatus comprising:
a processor executing code stored in a memory to perform:
receiving an operation workflow for a compute system comprising at least two compute units;
generating at least two workflow slices randomly within a solution space of allocations of the operation workflow to the compute units;
determining a solution score for each workflow slice;
iteratively generating a cousin workflow slice adjacent to each workflow slice with a solution score that satisfies a solution score criteria; and
in response to satisfying a stop criteria, selecting a workflow slice with a highest solution score.

11. The apparatus of claim 10, the process further randomly generating an additional workflow slice within the solution space in response to no workflow slices exceeding the solution score criteria.

12. The apparatus of claim 10, the processor further executing the selected workflow slice with the compute system.

13. The apparatus of claim 10, wherein cousin workflow slices differ by no more than ten allocations of tasks.

14. The apparatus of claim 10, wherein the solution score comprises a process time.

15. The apparatus of claim 10, wherein the stop criteria comprises a selection time limit.

16. The apparatus of claim 10, wherein the operation workflow is an Open Neural Network Exchange (ONNX) workflow.

17. The apparatus of claim 10, wherein the compute system comprises at least four compute units and a controller that communicates with the plurality of compute units.

18. The apparatus of claim 17, wherein the controller and the compute units communicate using a single point of contact network.

19. The apparatus of claim 18, wherein each compute unit comprises a Field-Programmable Gate Array (FPGA).

20. A computer readable program product comprising a non-transitory computer medium storing code executed by a processor to perform:
receiving an operation workflow for a compute system comprising at least two compute units;
generating at least two workflow slices randomly within a solution space of allocations of the operation workflow to the compute units;
determining a solution score for each workflow slice;
iteratively generating a cousin workflow slice adjacent to each workflow slice with a solution score that satisfies a solution score criteria; and
in response to satisfying a stop criteria, selecting a workflow slice with a highest solution score.
